(19) United States
(12) Patent Application Publication
(10) Pub. No.: US 2017/0127675 A1
(43) Pub. Date: May 11, 2017

(54) COMPOSITIONS AND METHODS FOR CONTROLLING INSECT POPULATIONS

(71) Applicant: OLFACTOR LABORATORIES, INC., Riverside, CA (US)

(72) Inventors: Michelle Ardella Brown, Hemet, CA (US); Martin Antonio Lomeli, Jr., Moreno Valley, CA (US); Samer Elkashef, Moreno Valley, CA (US)

(73) Assignee: OLFACTOR LABORATORIES, INC., Riverside, CA (US)

(21) Appl. No.: 15/318,866

(22) PCT Filed: Jun. 26, 2015
(86) PCT No.: PCT/US15/37888

§ 371 Date: Dec. 14, 2016

Related U.S. Application Data
(60) Provisional application No. 62/017,963, filed on Jun. 27, 2014.

(51) Int. Cl. A01N 43/16

(52) U.S. Cl. CPC A01N 43/16

(57) ABSTRACT

The present invention provides biocides as well as methods of use thereof for controlling pests, particularly vector pests such as mosquitoes and other hematophagous pests.

### CROSS REFERENCE TO RELATED APPLICATIONS

The present application claims priority to U.S. Provisional Patent Application No. 62/017,963, filed Jun. 27, 2014, entitled Compositions and Methods for Controlling Insect Populations, the contents of which are herein incorporated by reference in their entirety.

### FIELD OF THE INVENTION

The present invention relates to the field of carbohydrate biocides as well as methods of eradicating vector pests such as mosquitoes and other hematophageous pests, and the like.

### BACKGROUND OF THE INVENTION

Mosquito-borne illnesses are responsible for the deaths of more than one million people annually. Malaria is one such illness posing a major health problem in tropical and subtropical regions. Another global killer is the Dengue virus, transmitted by Aedes aegypti which infects 100 million people annually primarily in Latin America and Asia. Mosquito-borne illnesses are also on the rise in the United States. Since the first reported human infections in New York State in 1999, the West Nile Virus has steadily moved south and west with detection currently recorded in all of the States of the continental United States. Eastern Equine Encephalitis (EEE) is another arbovirus transmitted by mosquitoes that is also causing illness in individuals in the United States as well as in Central and South America. Serious infections of EEE are characterized by seizures and coma leading to death in about half of these patients. Therefore, there exists a worldwide need for safe, effective and affordable agents to protect humans from mosquitoes and other vector pests.

It is known that mosquitoes rely on sources of natural plant sugars for energy. While females may also rely on blood meals, sugars are the only food source for male mosquitoes. Sugar sources may include nectars, fruits and seedpods (Beier, J. C. et al., Malar J. 2012. 11:31). Studies indicate that blood meals better support reproduction, while sugar meals provide greater support for lipid accumulation, an important factor for surviving overwinter dormancy (diapause) (Robich, R. M. et al., Proc Natl Acad Sci USA. 2005 Nov. 1; 102(44):15912-7).

There is a long history of insecticides using sugar as bait for such insects as ants and cockroaches, wherein a toxicant is embedded to kill these insects (see US2009/0148398, US2003/0074832 and PCT/US2007/021062). Taking advantage of the attraction of mosquitoes to sugar solutions, the art teaches the use of sugar-treated oral toxins as insecticides (see US2007/0269404 and U.S. Pat. No. 3,937,826). These toxins utilize a bait comprising sugar with an additional toxicant, such as boric acid, that kills the insects.

The present invention provides carbohydrate (sugar) compounds and/or compositions that are directly toxic to pests, including, but not limited to mosquitoes. Such toxic sugar compounds and/or compositions are desirable for use in pest control due to their high specificity and low toxicity. They may even be dispensed alone or in combination with digestible sugars (e.g. sucrose). The compounds described herein include a number of natural products, potentially making them less harmful to the environment and to human health.

Thus, the methods and compositions described herein which control vector pest populations represent a solution to address the long felt need for improved vector pest control with minimal risk to humans and the environment.

### SUMMARY OF THE INVENTION

In some embodiments, the present invention provides biocides. Biocides of the present invention may comprise one or more toxic sugars. In some embodiments, biocides of the present invention comprise one or more toxic sugars selected from the group consisting of monosaccharides, disaccharides, oligosaccharides and saponins. Biocides comprising monosaccharides may comprise methyl-beta-D-galactopyranoside. Biocides comprising disaccharides may comprise one or more of alpha,beta-trehalose, D-(+)-cellobiose, melibiose, n-acetyl allolactosamine, 4-O-beta-galactopyranosyl-D-mannopyranose, D-(+)-turanose and rutin hydrate. Biocides comprising oligosaccharides may comprise D-(+)-raffinose pentahydrate. Biocides comprising saponins may comprise glycyrrhizic acid ammonium salt.

In some embodiments, one or more toxic sugars are present in a given biocide at a concentration selected from the group consisting of from about 0.01% to about 1%, from about 0.05% to about 5%, from about 0.1% to about 10%, from about 0.5% to about 50% and from about 25% to about 100%. In some embodiments, biocides of the present invention may comprise sucrose. In some embodiments, biocides of the present invention may comprise environmentally safe components. In some embodiments, biocides of the present invention may comprise one or more attractant compounds. In some embodiments, one or more toxic sugars of the present invention are also attractants. In such embodiments, such toxic sugars may be consumed by one or more pests and in some embodiments, lead to the death of such pests.

In some embodiments, the present invention provides a method of controlling one or more pests comprising the use of a biocide comprising one or more toxic sugars selected from the group consisting of monosaccharides, disaccharides, oligosaccharides and saponins. According to such methods, controlling one or more pests may include one or more of retarding growth, retarding reproduction, repelling, neutralizing harmful effects, sterilizing, immobilizing and killing such pests. In some embodiments, methods of the present invention comprise the consumption of biocides by pests. In some embodiments, biocides of the present invention are lethal. In some embodiments, methods of the present invention comprise vector pests. In such embodiments, vector pests may be selected from the group consisting of mosquitoes, sand flies, black flies and biting midges. According to some methods of the present invention, one or more vector pests are flying dipterans selected from the group consisting of members of the mosquito family Culicidae (including, but not limited to members of the genus Aedeomyia, members of the genus Aedes (including, but not limited to Aedes aegypti), members of the genus Anopheles (including, but not limited to Anopheles gambiae and Anopheles annulipes), members of the genus Armigeres, members of the genus Ayurakitia, members of the genus Bironella, members of the genus Borichinda, members of the genus Chagasia, members of the genus Coquillettidia, member of the genus Culex (including, but not limited to Culex quinquefasciatus, Culex molestus, Culex annulirostris and Culex australicus), members of the genus Culiseta, members of the genus Deinocerites, members of the genus Eretmapodites, members of the genus Ficalbia, members of the genus Galindomyia, members of the genus Haemagogus, members of the genus Heizmannia, members of the genus Hodgesia, members of the genus Isostomyia, members of the genus Johnbelkinia, members of the genus Kimia, members of the genus Limatus, members of the genus Lutzia, members of the genus Malaya, members of the genus Mansonia, members of the genus Maorigoeldia, members of the genus Mimomyia, members of the genus Onirion, members of the genus Opifex, members of the genus Orthopodomyia, members of the genus Psorophora, members of the genus Runchomyia, members of the genus Sabethes, members of the genus Shannoniana, members of the genus Topomyia, members of the genus Toxorhynchites, members of the genus Trichoprosopon, members of the genus Tripteroides, members of the genus Udaya, members of the genus Uranotaenia, members of the genus Verrallina, members of the genus Wyeomyia, members of the genus Zeugnomyia), biting midges of the family Ceratopogonidae (including, but not limited to members of the genus Culicoides (including, but not limited to Culicoides sonorensis), members of the genus Leptoconops (including, but not limited to Leptoconops albiventris and Leptoconops torrens) and members of the genus Forcipomyia), black flies of the family Simuliidae (including, but not limited to members of the genus Simulium (including, but not limited to Simulium damnosum, Simulium neavei, Simulium callidum, Simulium metallicum, Simulium ochraceum, Simulium colombaschense, Simulium pruinosum and Simulium posticatum) and sand flies (including but not limited to members of the genus Lutzomyia (including, but not limited to Lutzomyia longipalpis) and members of the genus Phlebotomus (including, but not limited to Phlebotomus papatasi)). In such embodiments, vector pests may be mosquitoes of the genus Anopholes, Culex or Aedes.

In some embodiments, the present invention provides methods of trapping one or more pests comprising using one or more biocides of the present invention in conjunction with a trap. In such embodiments, biocides of the present invention may be attractants for one or more pests. In some embodiments, biocides of the present invention may be used to control one or more pests from overcrowding a trap and/or a bait or lure present in, on or around a trap.

### DETAILED DESCRIPTION OF THE INVENTION

Given the tremendous impact vector pests have on the human condition, it is of great interest and imperative that compositions and methods be developed to minimize the deleterious effects these species have on the transmission of disease in animal species, especially humans and domesticated animals.

Described herein are compounds and/or compositions (including pharmaceutical compositions) and methods for the design, preparation and manufacture of compounds which may modulate pest behavior and/or well-being and/or kill such pests.

In some embodiments, compounds and/or compositions of the present invention may attract one or more pests. Such attraction may result from exposing such pests to compounds and/or compositions of the present invention in one or more forms. As used herein, the term “exposing” refers to applying a compound or composition to an object, surface, area, or region and/or to any part of a pest in such a manner and in sufficient proximity to a pest as to allow the sensing (e.g. touching, tasting, smelling, seeing, hearing, cell receptor-mediated signaling, electrical sensing, etc) of the compound or composition by the pest. In some embodiments, exposure may comprise ingestion of a given agent. In some embodiments, exposure may comprise contact with a pest mucous membrane. In some embodiments, exposure may comprise absorption of an agent into a pest circulatory system. In some embodiments, exposure may comprise the interaction of an agent with one or more moieties present on one or more surfaces of one or more pest.

As used herein, an “attractant” is any compound, composition or combination capable of attracting one or more pests. Attractants may be used as a bait or lure. As used herein, a “bait” or “lure” is any agent capable of attracting one or more pests to a specific location or trap.

In some embodiments, the present invention provides compounds, compositions and methods which ameliorate, reduce, or eliminate the deleterious effects on human (or animal) health caused by pests, especially vector pests. As such, the present inventions are useful for the prevention of vector-borne illnesses in individuals, groups of individuals and/or large populations as well as the spread of said illnesses. Said illnesses may include, but are not limited to malaria, dengue, yellow fever, sleeping sickness, West Nile virus, Lyme disease, Eastern equine encephalitis, river blindness, lymphatic filariasis, leishmaniasis, epidemic polyarthritis, Australian encephalitis and the like.

As used herein, a “pest” refers to any organism that causes harm, irritation, discomfort or general annoyance to humans and/or other animals. “Vector pests” are those organisms that are capable of carrying and/or transmitting a viral, bacterial, protozoan or other pathogen from reservoir to host.

Most vector pests are arthropod insects and may be hematophagous. Pests and/or vector pests may also include biting insects. Vector pests which are of the order Hemiptera may include, but are not limited to vector pests which are of the order Diptera, including flying dipterans (the term “flying dipterans” as used herein refers to any members of the order Diptera that are capable of flight), which may include, but are not limited to, members of the mosquito family Culicidae (including, but not limited to members of the genus Aedeomyia, members of the genus Aedes (including, but not limited to Aedes aegypti), members of the genus Anopheles (including, but not limited to Anopheles gambiae and Anopheles annulipes), members of the genus Armigeres, members of the genus Ayurakitia, members of the genus Bironella, members of the genus Borichinda, members of the genus Chagasia, members of the genus Coquillettidia, members of the genus Culex (including, but not limited to Culex quinquefasciatus, Culex molestus, Culex annulirostris and Culex australicus), members of the genus Culiseta, members of the genus Deinocerites, members of the genus Eretmapodites, members of the genus Ficalbia, members of the genus Galindomyia, members of the genus Haemagogus, members of the genus Heizmannia, members of the genus Hodgesia, members of the genus Isostomyia, members of the genus Johnbelkinia, members of the genus Kimia, members of the genus Limatus, members of the genus Lutzia, members of the genus Malaya, members of the genus Mansonia, members of the genus Maorigoeldia, members of the genus Mimomyia, members of the genus Onirion, members of the genus Opifex, members of the genus Orthopodomyia, members of the genus Psorophora, members of the genus Runchomyia, members of the genus Sabethes, members of the genus Shannoniana, members of the genus Topomyia, members of the genus Toxorhynchites, members of the genus Trichoprosopon, members of the genus Tripteroides, members of the genus Udaya, members of the genus Uranotaenia, members of the genus Verrallina, members of the genus Wyeomyia and members of the genus Zeugnomyia), biting midges of the family Ceratopogonidae (including, but not limited to members of the genus Culicoides (including, but not limited to Culicoides sonorensis), members of the genus Leptoconops (including, but not limited to Leptoconops albiventris and Leptoconops torrens) and members of the genus Forcipomyia), black flies of the family Simuliidae (including, but not limited to members of the genus Simulium (including, but not limited to Simulium damnosum, Simulium neavei, Simulium callidum, Simulium metallicum, Simulium ochraceum, Simulium colombaschense, Simulium pruinosum and Simulium posticatum) and sand flies (including but not limited to members of the genus Lutzomyia (including, but not limited to Lutzomyia longipalpis) and members of the genus Phlebotomus (including, but not limited to Phlebotomus papatasi)).

### Compounds, Compositions and Combinations

The present invention provides carbohydrate biocides, or toxic sugars as well as methods for the use thereof. As used herein, the term “toxic sugar” refers to carbohydrate compounds that comprise some level of toxicity to one or more pests. In some embodiments, such compounds may also act as attractants. In some embodiments, such compounds are consumed by one or more pests. Toxic sugars of the present invention may be categorized according to different structural and chemical properties. These categories include, but are not limited to monosaccharides, disaccharides, oligosaccharides and saponins.

### Monosaccharide Compounds

In some embodiments, carbohydrate biocides or toxic sugars of the present invention comprise monosaccharides. As used herein, the term “monosaccharide” refers to the simplest form of sugar, a single sugar residue, free of glycosidic bonds with other sugars. It may also be used to describe the identity of a single sugar residue within a larger polysaccharide. Examples of monosaccharides include, but are not limited to glucose, galactose, xylose, fructose and ribose. Monosaccharides may also be categorized according to the number of carbon atoms present within their skeletons (e.g. dioses—2 carbon atoms, trioses—3 carbon atoms, tetroses—4 carbon atoms, pentoses—5 carbon atoms, hexoses—6 carbon atoms, heptoses—7 carbon atoms, etc.) Monosaccharides are chiral and stereoisomers are assigned the prefixes D- or L-depending on the orientation of hydrogen and hydroxyl groups bonded to the carbons of the skeleton.

Additionally, the prefixes (+)- and (−)- are used to indicate the sign of the optical rotation under specific conditions (McNaught, A. D., Pure & Appl. Chem, 1996. 68(10):1919-2008). Many modified monosaccharides exist including, but not limited to amino sugars (e.g. galactosamine, glucosamine, sialic acid, N-acetylglucosamine and N-acetylgalactosamine), methylated sugars, acetylated sugars and sulfated sugars. In some embodiments, compounds and/or compositions of the present invention comprise the monosaccharide methyl-beta-D-galactopyranoside.

### Disaccharide Compounds

In some embodiments, carbohydrate biocides or toxic sugars of the present invention comprise disaccharides. As used herein, the term “disaccharide” refers to a chain of sugars comprising two monosaccharides. Examples of disaccharides include, but are not limited to sucrose, lactose, maltose, lactulose, trehalose, melibiose, turanose and rutinose. Monosaccharides within a disaccharide chain are linked through ether bonds referred to as “glycosidic bonds”. These bonds may form according two different stereochemical orientations, alpha or beta. Alpha-glycosidic bonds are formed in an axial orientation, while beta-glycosidic bonds are formed in an equatorial orientation. In some embodiments of the present invention, compounds and/or compositions comprising disaccharides include, but are not limited to alpha, beta-trehalose, D-(+)-cellobiose, melibiose, N-acetylallolactosamine, 4-O-beta-galactopyranosyl-D-mannopyranose, D-(+)-turanose, rutin hydrate and sucrose octasulfate-aluminum complex.

### Oligosaccharide Compounds

In some embodiments, carbohydrate biocides or toxic sugars of the present invention comprise oligosaccharides. As used herein, the term “oligosaccharide” refers to a sugar molecule comprising from 2 to about 10 monosaccharide residues. Oligosaccharide compounds and/or compositions of the present invention may include D-(+)-raffinose pentahydrate.

Saponin Compounds

In some embodiments, biocide compounds and/or compositions of the present invention may comprise saponins. As used herein, the term “saponin” refers to a class of plant-derived glycosides comprising a hydrophilic region (typically comprising one or more oligosaccharide chains) associated with a hydrophobic region comprising either a steroid or triterpenoid chemical structure (see EP0785802, the contents of which are incorporated herein by reference in their entirety).

Due to their amphipathic structure, plants and roots comprising saponins have found historical uses as soaps. Plants comprising saponins include, but are not limited to the soapwort plant, ginseng, the soap bark tree, members of the genus Glycyrrhiza (including, but not limited to Glycyrrhiza glabra, Glycyrrhiza lepidota, Glycyrrhiza echinata, Glycyrrhiza uralensis, Glycyrrhiza acanthocarpa, Glycyrrhiza aspera, Glycyrrhiza astragalina, Glycyrrhiza bucharica, Glycyrrhiza eglandulosa, Glycyrrhiza foetida, Glycyrrhiza foetidissima, Glycyrrhiza gontscharovii, Glycyrrhiza iconica, Glycyrrhiza inflata, Glycyrrhiza korshinskyi, Glycyrrhiza Glycyrrhiza squamulosa, Glycyrrhiza triphylla and Glycyrrhiza yunnanensis), members of the genus Agave (including, but not limited to Agave attenuate), members of the genus Panax (including, but not limited to Panax ginseng), members of the genus Saponaria (including, but not limited to Saponaria officinalis), members of the genus Allium (including, but not limited to Allium sativum), members of the genus Medicago (including, but not limited to Medicago sativa), members of the genus Cestrum (including, but not limited to Cestrum parqui). Some saponins may also be extracted from marine organisms, including, but not limited to members of the Asteriidae family (including, but not limited to the Antarctic starfish) and marine sponges [including, but not limited to members of the Ectyoplasia genus (e.g. Ectyoplasia ferox)] (Chaieb, I., Saponins as insecticides: a review. Tunisian Journal of Plant Protection. 2010. 5:39-50). In some embodiments of the present invention, compounds and compositions of the present invention may comprise the saponin glycyrrhizic acid and/or its ammonium salt, derived from licorice root.

Biocidal and/or Lethal Compounds

Compounds and/or compositions of the present invention may comprise biocides. As used herein, the term “biocide” refers to any agent capable of controlling (e.g. retarding growth, retarding reproduction, repelling, neutralizing, sterilizing, immobilizing) and/or killing a living organism. In some embodiments, such organisms are pests. In some embodiments, such pests are vector pests. As used herein, the term “biocidal activity” refers to the controlling capability of a given biocide. In some embodiments, biocides include carbohydrate biocides, such as toxic sugars.

Biocide compounds and/or compositions of the present invention may be lethal. As used herein the term “lethal” is used to refer to any agent capable of causing death in one or more organisms that are exposed to such an agent. In some embodiments, such organisms are pests. In some embodiments, such pests are vector pests. As used herein, the term “lethality” refers to the capability of a given agent to cause death in one or more organisms exposed to such an agent.

In some embodiments, compounds and/or compositions of the present invention are biocidal and/or lethal upon exposure to one or more pests. In some embodiments, such exposure comprises ingestion of one or more compounds and/or compositions of the present invention. In some embodiments, biocidal and/or lethal activity of compounds and/or compositions of the present invention may exert such effects directly upon exposure and/or indirectly through one or more cascades of events initiated by exposure.

In some embodiments, compounds and/or compositions of the present invention may comprise any of those listed in Table 1. Additional biocidal agents that may be included in compositions of the present invention include any of those disclosed in International Publication No. WO2014/028835 (including any of those listed in Table 4 or 5 of that publication,) the contents of which are herein incorporated by reference in their entirety.

TABLE 1
Compounds

| Compound | Class |
|---|---|
| methyl-beta-D-galactopyranoside | monosaccharide |
| alpha,beta-trehalose | disaccharide |
| D-(+)-cellobiose | disaccharide |
| melibiose | disaccharide |
| n-acetyl allolactosamine | disaccharide |
| 4-O-beta-galactopyranosyl-D-mannopyranose | disaccharide |
| D-(+)-turanose | disaccharide |
| D-(+)-raffinose pentahydrate | oligosaccharide |
| rutin hydrate | disaccharide |
| glycyrrhizic acid ammonium salt | saponin |
| sucrose octasulfate aluminum complex | disaccharide |

### Formulations

The compounds and/or compositions of the present invention may be part of a formulation. As used herein, a “formulation” is a combination of one or more compounds and/or compositions prepared as per a formula and may include one or more excipients, carriers or delivery agents. Formulations may be dry or wet or may be solid or liquid. Formulations may be designed for one or more particular applications or uses. Biocidal formulations may comprise 1, 2, 3 or more toxic sugars or carbohydrate biocides.

Biocidal formulations of the compounds and/or compositions of the present invention may be deployed by aerosolization via sublimation, spray, vaporization, candle burning and the like. They may be deployed as solids such as blocks, rods, crystals, granules, pellets, beads, powders and the like for release of vapors over time. Some formulations may be designed for slow release.

In other embodiments, the compounds and/or compositions of the invention may be used in liquid form, either as purified liquids or in aqueous-based or non-aqueous (organic) formulations. As used herein the term “aqueous” means similar to or containing or dissolved in water, e.g., an aqueous solution. A “slurry,” according to the present invention, is a suspension of predominantly insoluble particles, usually in water. Suitable liquid diluents or carriers include water, petroleum distillates, or other liquid carriers. In one embodiment, said diluents further comprise surface active agents. Non-ionic, anionic, amphoteric, or cationic dispersing and emulsifying agents may be employed. The choice of liquid formulation components is dictated by the intended use of the composition, the desired distribution of the active compounds within the formulation and the ability of the formulation to be effectively spread across the desired treatment area. Said liquid formulations may be in the form of lotion, spray, foam, gel, balm, cream, mousse, patch, suspension, emulsion, microemulsion, emulsifiable concentrate, pump spray, fragrance, perfume, cologne, roll on, solid stick, gel stick, towelette, wet wipe, ointment, salve, paste and the like.

### Attractants

Biocidal compounds and/or compositions of the invention may be formulated with attractants known in the art. These attractant formulations may comprise one or more of the following: sugar, honey, molasses, plant oils, animal oils (such as fish oil and the like), plant extracts, floral odors, pheromones, proteins, salt, seeds, animal feed, livestock feed, sticky agents, adhesives (including substances such as tanglewood), and the like.

In some embodiments, compounds and/or compositions of the present invention may comprise one or more of the attractant compounds listed in Table 2. Additional activators and activator compositions may be selected from any of those listed in International Publication No. WO2014/028835 (including any of those listed in Table 1 of that publication,) the contents of which are herein incorporated by reference in their entirety. Such activator compositions may comprise two, three or more compound combinations (including any of those listed in Table 8 of WO2014/028835,) synergistic combinations (including any of those listed in Table 9 of WO2014/028835) and/or combinations comprising environmentally friendly compounds as disclosed therein.

TABLE 2
Activator Compounds
Compound

2,4-lutidine
2-ethylpyrazine
2-methoxypyrazine
2-methyltetrahydrofuran-3-one
4-ethylphenol
5-methylfurfural
butylformate
cyclopentanone
ethyllactate
ethylvinylcarbinol
trans-2-methyl-2-butenal
guaiacol
ethyl 2-furoate
2,3,5-trimethylpyrazine
2,3-dimethylpyrazine
2-acetyl-5-methyl furan
2-furyl methyl ketone
2-pentanone
allylbutyrate
cinnamylnitrile
ethyl 3-hydroxyhexanoate
ethylacetoacetate
ethylvinylketone
gamma-heptalactone
methanethiolacetate
phenylpropylaldehyde
phenylacetaldehyde
methyl crotonate
methyl levulinate
isobutyl acetate
isobutyl propionate
isopropyl tiglate
isobutyl trans-2-butenoate
methyl isovalerate
2-methoxy-4-methylphenol
isopropyl butyrate
2,4-dimethylbenzaldehyde
2,4-dimethyl-3-cyclohexene-
carboxaldehyde (mixture of
cis/trans forms)
2-ethyl-5(6)-methylpyrazine
2-phenylpropionaldehyde
3-hexanone
4-ethylbenzaldehyde
4-oxoisophorone
acetyl-2-pyrazine
butan-3-one-2yl butanoate
dimethylsuccinate
dipropylenglykol-monomethylether
ethyl 3-hydroxybutyrate
ethylformate
ethylisobutyrate
ethylisovalerate
ethyllevulinate
ethyl-2,3,5(6)-dimethylpyrazine
furfurylethylether
heptaldehyde
heptanone-4
hexanal
indole
methylheptadienone
m-tolualdehyde
o-anisaldehyde
prenylacetate
propylformate
R-+ pulegone
trans-cinnamaldehyde
valeraldehyde

Biocidal compounds and/or compositions of the invention may be formulated for topical use on a given subject. Such subjects may be human and/or non-human animals such as dogs, cats, horses, equines, bovines and others vulnerable to vector pests. In some embodiments, topical formulations may be applied to the skin of one or more subject. The compounds and/or compositions may also be formulated for application to materials such as clothing or apparel. Such materials may also include bedding, netting, screens, curtains, walls, gear, equipment, vehicles and the like.

### Other Components of Formulations

Formulations containing biocidal compounds and/or compositions of the present invention may comprise further components depending upon the desired use of the formulation. These components include, but are not limited to carriers, thickeners, surface-active agents, preservatives, aromatics, deodorizers, and one or more of several types of adjuvant including, but not limited to, wetting agents, spreading agents, sticking agents, foam retardants, buffers and acidifiers. In another embodiment, the compounds and/or compositions of the present invention may be supplied as a concentrate which may be diluted to achieve a desired strength depending on the application. The term “concentrate” as used herein, refers to a compound and/or composition in condensed form. A concentrate therefore may contain some diluents and not necessarily be purified.

### Carriers

The compounds and/or compositions of the present invention may contain one or more carriers or carrier vehicles. Such carriers may be gaseous, liquid or solid and are most often inert but may be active ingredients. Carrier vehicles may include, but are not limited to, aerosol propellants, such as freon, (present in a gaseous state at normal temperatures and pressures); inert dispersible liquid diluent carriers, including inert organic solvents, aromatic hydrocarbons (such as benzene, toluene, xylene, alkyl naphthalenes, etc.), halogenated especially chlorinated, aromatic hydrocarbons (such as chloro-benzenes, etc.), chlorinated aliphatic hydrocarbons (such as chloroethylenes, methylene chloride, etc.), cycloalkanes, (such as cyclohexane, etc.), paraffins (such as petroleum or mineral oil fractions), acetonitrile, ketones (such as cyclohexanone, methyl ethyl ketone, acetone, methyl isobutyl ketone, etc.), alcohols (such as ethanol, methanol, propanol, glycol, butanol, etc.) as well as ethers and esters thereof (such as glycol monomethyl ether, etc.), amides (such as dimethylformamide etc.), amines (such as ethanolamine, etc.), sulfoxides (such as dimethylsulfoxide, etc.), and/or water. Carriers may also include inert, finely divided solid carriers that may be dispersible such as ground natural minerals (including, but not limited to chalk, i.e. calcium carbonate, silica, alumina, vermiculite, talc, kieselguhr, attapulgite, montmorillonite, etc.) as well as ground synthetic minerals (such as highly dispersed silicic acid, silicates, such as alkali silicates, etc.).

### Finely Divided Solid Carrier Formulations

The compounds and/or compositions of the present invention may be formulated for dispersion with finely divided solid carriers such as dust, talc, chalk, diatomaceous earth, vermiculite, sand, sulfur, flours, attapulgite clay, kieselguhr, pyrophyllite, calcium phosphates, calcium and magnesium carbonates, and other solids capable of acting as carriers. A typical finely divided solid formulation useful for modifying vector pest behavior contains 1 part compound and/or composition per 99 parts of said finely divided solid carrier. In one embodiment, these finely divided solids have an average particle size of about >50 microns. In another embodiment, said finely divided solids are granules. The term “granule,” as used herein refers to particles of a diameter of about 400-2500 microns. Said granules may comprise porous or nonporous particles. Finely divided solid carriers may be either impregnated or coated with the desired compound and/or composition. Granules generally contain 0.05-15%, preferably 0.5-5%, of the active compound and/or composition. Thus, the compounds and/or compositions of the present invention may be formulated with any of the following solid carriers such as bentonite, fullers earth, ground natural minerals (such as kaolins, quartz, attapulgite, montmorillonite, etc.), ground synthetic minerals (such as highly-dispersed silicic acid, alumina and silicates), crushed and fractionated natural rocks (such as calcite, marble, pumice, sepiolite and dolomite), synthetic granules of inorganic and organic meals, and granules of organic materials (such as sawdust, coconut shells, corn cobs, tobacco stalks, walnut or other nut shells, egg shells and other natural cast off products that may or may not be a by-product of manufacturing or harvest).

### Surface-Active Agents

Formulations containing compounds and/or compositions of the present invention may include surface-active agents. “Surface-active agents” as referred to herein, are additives capable of lowering the surface tension of a liquid or between a liquid and a solid. Surface-active agents may include, but are not limited to emulsifying agents (such as non-ionic and/or anionic emulsifying agents, polyethylene oxide esters of fatty acids, polyethylene oxide ether of fatty alcohols, alkyl sulfates, alkyl sulfonates, aryl sulfonates, albumin hydrolyzates, alkyl arylpolyglycol ethers, magnesium stearate, sodium oleate, etc.) and/or dispersing agents (such as lignin, sulfite waste liquors, methyl cellulose, etc.).

### Thickeners

Formulations comprising biocidal compounds and/or compositions of the present invention may contain one or more thickeners. The term “thickener”, as used herein refers to an additive that increases the viscosity of the formulation to which it is added without significantly modifying other properties of the formulation. They may also be used to impart a uniform consistency to the formulation. They are also useful for keeping components of a given formulation in suspension. Said thickeners include, but are not limited to agar, corn starch, guar gum and potato starch. Thickeners may be present at a concentration of from about 0.1% to about 5% of the total composition.

### Preservatives

Formulations comprising biocidal compounds and/or compositions of the present invention may contain one or more preservatives. As used herein, the term “preservative” refers to an additive capable of preventing decay, decomposition or spoilage in a composition. Said preservatives may be natural or synthetic; they may protect against a broad spectrum of spoilage or be targeted to one form (such as microbial, fungal or molding spoilage). Preservatives may include, but are not limited to, calcium propionate, sodium nitrate, sulfur dioxide, sodium bisulfate, potassium hydrogen sulfite, disodium ethylenediaminetetraacetic acid (EDTA), formaldehyde, glutaraldehyde, ethanol, methylchloroisothiazolinone, potassium sorbate, and the like.

Other preservatives protect against chemical breakdown of compounds or compositions. Such preservatives include butylated hydroxyanisole (BHA) and butylated hydroxytoluene (BHT). Preservatives are typically present in formulations at a concentration from about 0.03% to about 3% by weight.

### Other Ingredients

The compounds and/or compositions of the invention may include “other ingredients” known to those skilled in the art and which may be added to formulations depending on the desired application. These include, but are not limited to milk, garlic, garlic powder, garlic oil, hot pepper, white pepper, oil of black pepper, piperine, chemically formulated pepper, clove, fish oil, optionally modified oil, onion, perfumes, bitrex, thiram, thymol, capsaicin, predator urines, urea, naphthalene (moth balls), pyrethrine, blood, blood meal, bone meal, sulfurous emitting items (eggs, sulfur, meats, etc), denatonium benzoate, formaldehyde, ammonia, methyl ammonium saccharide, ammonium of fatty acids, waxes, nutrients, butyl mercaptan, mineral oil, orange oil, kelp (seaweed), whole eggs, powdered eggs, putrescent eggs, egg whites, egg yolks, rotten eggs, rosemary, thyme, wintergreen, clay, 2-propenoic acid, potassium salt, 2-propeniamide, acetic acid, iron, manganese, boron, copper, cobalt, molybdenum, zinc, latex, animal glue and stickers like NU FILM P® and others in the series. Other ingredients may be present in concentrations of from about 0.1% to about 10%.

### Environmentally Safe Compounds

Formulations of biocidal compounds and/or compositions of the invention may contain environmentally safe compounds. As used herein, an “environmentally safe compound” is a compound that imposes reduced, limited, minimal and/or no harm to a given ecosystem or environment. Harmful chemicals are often used to control pests and biting insects. With increasing public awareness of the dangers posed by some chemicals to public health and to the environment, natural compounds have been increasingly explored as alternatives to synthetic and/or hazardous chemicals. To this end, the Environmental Protection Agency has taken legislative action to categorize certain natural compounds as safe, protecting the use of these environmentally safe compounds from certain government regulations.

The Federal Insecticide, Fungicide and Rodenticide Act (FIFRA) outlines the exemptions as well as compounds covered by the act. In some embodiments, environmentally safe compounds include those identified as environmentally safe to use in pesticides by the Federal Insecticide, Fungicide and Rodenticide Act (FIFRA). Such compounds include, but are not limited to: (+)-butyl lactate; (+)-ethyl lactate; 1,2-propylene carbonate; 1-monolaurin; 1-monomyristin; 2-phenethyl propionate (2-phenylethyl propionate); acetyl tributyl citrate; agar; almond hulls; almond shells; alpha-cyclodextrin; aluminatesilicate; aluminum magnesium silicate; aluminum potassium sodium silicate; aluminum silicate; aluminum sodium silicate; aluminum sodium silicate (1:1:1); ammonium benzoate; ammonium stearate; amylopectin; acid-hydrolyzed; 1-octenylbutanedioate; amylopectin; hydrogen 1-octadecenylbutanedioate; animal glue; ascorbyl palmitate; attapulgite-type clay; beeswax; bentonite; bentonite, sodian; beta-cyclodextrin; bone meal; bran; bread crumbs; butyl lactate; butyl stearate; calcareous shale; calcite (Ca(Co₃)); calcium acetate; calcium acetate monohydrate; calcium benzoate; calcium carbonate; calcium citrate; calcium octanoate; calcium oxide silicate (Ca₃O(SiO₄)); calcium silicate; calcium stearate; calcium sulfate; calcium sulfate dihydrate; calcium sulfate hemihydrate; canary seed; carbon; carbon dioxide; carboxymethyl cellulose; cardboard; carnauba wax; carob gum; carrageenan; caseins; castor oil; castor oil, hydrogenated; cat food; cedar oil; cellulose; cellulose acetate; cellulose mixture (with cellulose carboxymethyl ether, sodium salt); cellulose, pulp; cellulose, regenerated; cheese; chlorophyll a; chlorophyll b; cinnamon and cinnamon oil; citric acid; citric acid, monohydrate; citronella and citronella oil; citrus meal; citrus pectin; citrus pulp; clam shells; cloves and clove oil; cocoa; cocoa shell flour; cocoa shells; cod-liver oil; coffee grounds; cookies; cork; corn cobs; corn gluten meal; corn oil; cotton; cottonseed meal; cottonseed oil; cracked wheat; decanoic acid; monoester with 1,2,3-propanetriol; dextrins; diatomaceous earth (less than 1% crystalline silica); diglyceryl monooleate; diglyceryl monostearate; dilaurin; dipalmitin; dipotassium citrate; disodium citrate; disodium sulfate decahydrate; dodecanoic acid; monoester with 1,2,3-propanetriol; dolomite; douglas fir bark; dried blood; egg shells; eggs; ethyl lactate; eugenol; feldspar; fish meal; fish oil (not conforming to 40 CFR 180.950); fuller's earth; fumaric acid; gamma-cyclodextrin; garlic and garlic oil; gelatins; gellan gum; geraniol; geranium oil; glue (as depolymd. animal collagen); glycerin; glycerol monooleate; glyceryl dicaprylate; glyceryl dimyristate; glyceryl dioleate; glyceryl distearate; glyceryl monomyristate; glyceryl monooctanoate; glyceryl monooleate; glyceryl monostearate; glyceryl stearate; granite; graphite; guar gum; gum arabic; gum tragacanth; gypsum; hematite (Fe₂O₃); humic acid; hydrogenated cottonseed oil; hydrogenated rapeseed oil; hydrogenated soybean oil; hydroxyethyl cellulose; hydroxypropyl cellulose; hydroxypropyl methyl cellulose; Iron magnesium oxide (Fe₂MgO₄); iron oxide (Fe₂O₃); iron oxide (Fe₂O₃), hydrate; iron oxide (Fe₃O₄); iron oxide (FeO); isopropyl alcohol; isopropyl myristate; kaolin; lactose; lactose monohydrate; lanolin; latex rubber; lauric acid; lauryl sulfate; lecithins; lemon grass oil; licorice extract; lime (chemical) dolomitic; limestone; linseed oil; magnesium benzoate; magnesium carbonate; magnesium oxide; magnesium oxide silicate (Mg₃O(Si₂O₅)₂), monohydrate; magnesium silicate; magnesium silicate hydrate; magnesium silicon oxide (Mg₂Si₃O₈); magnesium stearate; magnesium sulfate; magnesium sulfate heptahydrate; malic acid; malt extract; malt flavor; maltodextrin; methylcellulose; mica; mica-group minerals; milk; millet seed; mineral oil (U.S.P.); mint and mint oil; monomyristin; monopalmitin; monopotassium citrate; monosodium citrate; montmorillonite; myristic acid; nepheline syenite; nitrogen; nutria meat; nylon; octanoic acid, potassium salt; octanoic acid, sodium salt; oils, almond; oils, wheat; oleic acid; oyster shells; palm oil; palm oil, hydrogenated; palmitic acid; paper; paraffin wax; peanut butter; peanut shells; peanuts; peat moss; pectin; peppermint and peppermint oil; perlite; perlite, expanded; plaster of paris; polyethylene; polyglyceryl oleate; polyglyceryl stearate; potassium acetate; potassium aluminum silicate, anhydrous; potassium benzoate; potassium bicarbonate; potassium chloride; potassium citrate; potassium humate; potassium myristate; potassium oleate; potassium ricinoleate; potassium sorbate; potassium stearate; potassium sulfate; potassium sulfate; pumice; putrescent whole egg solids; red cabbage color (expressed from edible red cabbage heads via a pressing process using only acidified water); red cedar chips; red dog flour; rosemary and rosemary oil; rubber; sawdust; sesame (includes ground sesame plant stalks) and sesame oil; shale; silica (crystalline free); silica gel; silica gel, precipitated, crystalline-free; silica, amorphous, fumed (crystalline free); silica, amorphous, precipated and gel; silica, hydrate; silica, vitreous; silicic acid (H₂SiO₃), magnesium salt (1:1); soap (the water soluble sodium or potassium salts of fatty acids produced by either the saponification of fats and oils, or the neutralization of fatty acid); soapbark (Quillaja saponin); soapstone; sodium acetate; sodium alginate; sodium benzoate; sodium bicarbonate; sodium carboxymethyl cellulose; sodium chloride; sodium citrate; sodium humate; sodium lauryl sulfate; sodium oleate; sodium ricinoleate; sodium stearate; sodium sulfate; sorbitol; soy protein; soya lecithins; soybean hulls; soybean meal; soybean oil; soybean, flour; stearic acid; sulfur; syrups, hydrolyzed starch, hydrogenated; tetragylceryl monooleate; thyme and thyme oil; tricalcium citrate; triethyl citrate; tripotassium citrate; tripotassium citrate monohydrate; trisodium citrate; trisodium citrate dehydrate; trisodium citrate pentahydrate; ultramarine blue; urea; vanillin; vermiculite; vinegar (maximum 8% acetic acid in solution); Vitamin C; Vitamin E; walnut flour; walnut shells; wheat; wheat flour; wheat germ oil; whey; white mineral oil (petroleum); white pepper; wintergreen oil; wollastonite (Ca(SiO₃)); wool; xanthan gum; yeast; Zeolites (excluding erionite (CAS Reg. No. 66733-21-9)); Zeolites, NaA; zinc iron oxide; zinc metal strips (consisting solely of zinc metal and impurities); zinc oxide (ZnO) and zinc stearate. Environmentally safe compounds may be present in concentrations of from about 0.1% to about 10%, from about 1% to about 20%, from about 5% to about 50%, from about 25% to about 75% and/or from about 60% to about 100%.

### Aromatics

Formulations comprising biocidal compounds and/or compositions of the invention may comprise aromatic compounds and/or compositions. The term “aromatic” as used herein refers to a compound having a distinctive smell or aroma. Such compounds are typically volatile allowing for rapid diffusion into the surrounding air and easily sensed within the olfactory system. Aromatics that may be included in formulations of compounds and/or compositions of the invention include, but are not limited to camphor, pyrethrin and permethrin. Such formulations may comprise from about 0.01% to about 10%, from about 1% to about 5%, from about 2% to about 20% or from about 5% to about 50% camphor, pyrethrin and/or permethrin by weight percent.

### Adjuvants

Formulations comprising biocidal compounds and/or compositions of the invention may comprise adjuvants. The term “adjuvant”, as used herein refers to any substance that improves or enhances one or more properties of another component within the formulation. Said adjuvants may include, but are not limited to buffers, acidifiers, wetting agents, spreading agents, sticking agents, adhesives, colorants, stabilizers, waterproofing agents, foam retardants and the like. Such formulations may comprise from about 0.01% to about 10%, from about 1% to about 5%, from about 2% to about 20%, from about 5% to about 50% and/or at least 50% adjuvant.

Formulations with Other Known Agents

Formulations comprising biocidal compounds and/or compositions of the invention may comprise other compatible active agents known in the art including pesticides, insecticides, bactericides, fungicides, acaricides, microbicides, rodenticides, nematocides, herbicides and the like. The term “bactericide” refers to substances which may destroy or block the growth of bacteria; “fungicide” refers to substances which may destroy or block the growth of fungi; “acaricide” refers to substances which may destroy or block the growth of members of the Arachnida subclass, Acari; “microbicide” refers to substances which may kill or block the growth of microorganisms; “rodenticide” refers to chemical substances which may be capable of destroying rodents; “nematocide” refers to chemical substances which may be capable of destroying or blocking the growth of nematodes; “herbicide” refers to chemical substances which may be capable of destroying or blocking the growth of plant life. Such formulations may comprise from about 0.01% to about 10%, from about 1% to about 5%, from about 2% to about 20%, from about 5% to about 50% and/or at least 50% other active agents.

### Concentrations and Combinations

The biocidal compounds and/or compositions of the invention may be produced or formulated in various concentrations depending upon the desired application, vector pest, desired effect (e.g. attraction, repulsion, modulation of neuronal activity) and depending upon the type of surface or area that the invention will be applied to.

Typically active components within a given composition will be present in the composition in a concentration of at least about 0.0001% by weight. In another embodiment, active components may be present at a concentration from about 0.001% to about 0.01%, from about 0.001% to about 0.02%, from about 0.001% to about 0.03%, from about 0.001% to about 0.04%, from about 0.001% to about 0.05%, from about 0.001% to about 0.06%, from about 0.001% to about 0.07%, from about 0.001% to about 0.08%, from about 0.001% to about 0.09%, from about 0.001% to about 0.10%, from about 0.001% to about 0.11%, from about 0.001% to about 0.12%, from about 0.001% to about 0.13%, from about 0.001% to about 0.14%, from about 0.001% to about 0.15%, from about 0.001% to about 0.16%, from about 0.001% to about 0.17%, from about 0.001% to about 0.18%, from about 0.001% to about 0.19%, from about 0.001% to about 0.20%, from about 0.001% to about 0.21%, from about 0.001% to about 0.22%, from about 0.001% to about 0.23%, from about 0.001% to about 0.24%, from about 0.001% to about 0.25%, from about 0.001% to about 0.26%, from about 0.001% to about 0.27%, from about 0.001% to about 0.28%, from about 0.001% to about 0.29%, from about 0.001% to about 0.30%, from about 0.001% to about 0.31%, from about 0.001% to about 0.32%, from about 0.001% to about 0.33%, from about 0.001% to about 0.34%, from about 0.001% to about 0.35%, from about 0.001% to about 0.36%, from about 0.001% to about 0.37%, from about 0.001% to about 0.38%, from about 0.001% to about 0.39%, from about 0.001% to about 0.40%, from about 0.001% to about 0.41%, from about 0.001% to about 0.42%, from about 0.001% to about 0.43%, from about 0.001% to about 0.44%, from about 0.001% to about 0.45%, from about 0.001% to about 0.46%, from about 0.001% to about 0.47%, from about 0.001% to about 0.48%, from about 0.001% to about 0.49%, from about 0.001% to about 0.50%, from about 0.1% to about 1.0%, from about 0.1% to about 1.5%, from about 0.1% to about 2.0%, from about 0.1% to about 2.5%, from about 0.1% to about 3.0%, from about 0.1% to about 3.5%, from about 0.1% to about 4.0%, from about 0.1% to about 4.5%, from about 0.1% to about 5.0%, from about 0.1% to about 5.5%, from about 0.1% to about 6.0%, from about 0.1% to about 6.5%, from about 0.1% to about 7.0%, from about 0.1% to about 7.5%, from about 0.1% to about 8.0%, from about 0.1% to about 8.5%, from about 0.1% to about 9.0%, from about 0.1% to about 9.5%, from about 0.1% to about 10.0%, from about 0.1% to about 10.5%, from about 0.1% to about 11.0%, from about 0.1% to about 11.5%, from about 0.1% to about 12.0%, from about 0.1% to about 12.5%, from about 0.1% to about 13.0%, from about 0.1% to about 13.5%, from about 0.1% to about 14.0%, from about 0.1% to about 14.5%, from about 0.1% to about 15.0%, from about 0.1% to about 15.5%, from about 0.1% to about 16.0%, from about 0.1% to about 16.5%, from about 0.1% to about 17.0%, from about 0.1% to about 17.5%, from about 0.1% to about 18.0%, from about 0.1% to about 18.5%, from about 0.1% to about 19.0%, from about 0.1% to about 19.5%, from about 0.1% to about 20.0%, from about 1% to about 5%, from about 1% to about 10%, from about 1% to about 15%, from about 1% to about 20%, from about 1% to about 25%, from about 1% to about 30%, from about 1% to about 35%, from about 1% to about 40%, from about 1% to about 45%, from about 1% to about 50%, from about 1% to about 55%, from about 1% to about 60%, from about 1% to about 65%, from about 1% to about 70%, from about 1% to about 75%, from about 1% to about 80%, from about 1% to about 85%, from about 1% to about 90%, from about 1% to about 95%, from about 1% to about 100%, from about 10% to about 20%, from about 10% to about 30%, from about 10% to about 40%, from about 10% to about 50%, from about 10% to about 60%, from about 10% to about 70%, from about 10% to about 80%, from about 10% to about 90%, or from about 10% to about 100% by weight. Additionally, compounds may be combined in various embodiments such that compositions and formulations of the present invention contain 2, 3, 4, 5, 6, 7, 8, 9, 10, 11, 12, 13, 14, 15, 16, 17, 18, 19, 20 or more active compounds and/or compositions.

Units of measure used herein embrace standard units as well as metric units. It is to be understood that where compounds and/or compositions are measured, formulated or packaged in liquid form, the units may be in increments of ounces, cups, pints, quarts, gallons, barrels, or portions thereof. They may also be in metric increments of milliliters, cubic centimeters, deciliters, liters, cubic meters or portions thereof.

It is to be understood that where biocidal compounds and/or compositions are measured, formulated or packaged as solids, the units may have increments of ounces, pounds, tons, or portions thereof. They may also comprise increments of milligrams, grams, kilograms, metric tons or portions thereof.

Coverage, as it relates to the effective surface or area where vector pest behavior may be modified in response to application of a compound and/or composition of the invention, may be expressed in inches, feet, square feet, yards, square yards, acres, square acres, or portions thereof. They may also be in increments of millimeters, square millimeters, centimeters, square centimeters, meters, square meters, hectares, kilometers, square kilometers or portions thereof.

Methods of Application and/or Treatment

Biocidal compounds and/or compositions of the invention may be used to modify pest (e.g., vector pest) behavior in a given area or within the vicinity of one or more subjects and/or structures. In some embodiments, the present invention provides methods of controlling one or more biological organisms. Such control may include, but is not limited to retarding growth, retarding reproduction, repelling, neutralizing harmful effects, sterilizing, immobilizing and/or killing biological organisms. In some embodiments, such organisms are pests. In some embodiments, such pests are vector pests (e.g. mosquitoes).

Many methods of application are known in the art that would be convenient for applying compounds and/or compositions of the present invention to a desired object, individual, surface, area or region. Such methods include, but are not limited to aerosolizing, dusting, vaporizing, misting, spraying, spreading, broadcasting, spackling, sprinkling, painting, brushing, coating, rolling, banding, side-dressing, mopping, bathing, soaking, dipping, immersing, sticking, adhering, wiping, rubbing, impregnating, embedding, injecting, sealing, dotting, dabbing, stippling, layering, stenciling, stamping, pouring and the like. In some embodiments, biocidal compounds and/or toxic sugars of the present invention are applied to surfaces. Such surfaces may include, but are not limited to, any indoor and/or outdoor surface including, but not limited to tables, chairs, traps, rocks, trees, plants, the ground, lawns, patios, picnic tables, screens, windows and the like. In some embodiments, biocidal compounds and/or toxic sugars of the present invention are impregnated in adhesives and/or tacky substances. In some embodiments, pests are exposed to biocidal compounds and/or compositions of the present invention on or around the surface of a wick that draws from a solution comprising compounds and/or compositions of the present invention.

Methods of application may rely on indirect methods of dispersion. In one embodiment, compounds and/or compositions may be left in an area where they may be dispersed by active forces of nature such as wind, rain, sunlight, water current and the like. In another embodiment, a mechanical device may be used to effect the applications listed herein. In further embodiments, mechanical devices may be timed spreaders or broadcasters, set up in predetermined areas in order to apply or disperse compounds and/or compositions to a surface, area or substrate in a temporal fashion. Such mechanical devices may be automated or initiated remotely to apply compounds and/or compositions of the invention.

In some embodiments, biocidal compounds and/or compositions of the present invention may be used as part of a trap. In some embodiments, biocidal compounds and/or compositions of the present invention may be used as attractants and/or in combination with other attractants to lure pests to a trap. In some embodiments, compounds and/or compositions of the present invention may be used as biocides to control insects that may be overcrowding a trap and/or a bait or lure present in, on or around a trap.

Biocidal compounds and/or compositions of the present invention may be developed in conjunction with assays and/or testing to determine the effectiveness of such compounds and/or compositions or derivatives thereof. In some embodiments, testing is carried out to determine the effect of compounds and/or compositions of the present invention on pest behavior. Such testing may be used to determine the ability of biocidal compounds and/or compositions of the present invention to act as attractants or repellents.

In some embodiments, spatial experiments are carried out to determine the effect of compounds and/or compositions of the present invention on pest behavior (e.g. mosquito behavior). Such spatial experiments comprise the use of one or more spatial arenas. As used herein, the term “spatial arena” refers to any enclosed space. Such arenas may range in size from 1 ft³ to large arenas (including but not limited to semi-field chambers) of about 10,000 ft³. Materials used to enclose spatial arenas may vary depending upon the desired application. Materials may comprise one or more of plastic sheets, cloth, glass, netting, wood, sheetrock, fiberglass, screening, metal and the like. Spatial arenas may also be climate controlled. In such arenas, one or more of heat, light, humidity and air circulation may be controlled to limit experimental variation and/or simulate a given environment. Pest behaviors that may be observed during spatial experiments include, but are not limited to movement toward or away from a given agent, changes in pest movement level, immobilization, erratic movements and/or death.

In some embodiments, open arenas may be used. As used herein, the term “open arena” refers to any unbounded space where pests live, congregate and/or swarm. Examples of open arenas include, but are not limited to fields, yards, outdoor manmade spaces (e.g. patios, porches and/or parks).

In some embodiments, field testing is carried out to test biocidal compounds and/or compositions of the present invention. As used herein, the term “field testing” refers to testing done in one or more natural environments. Field testing may use traps to collect pests and/or record pest numbers at, in or around trap sites. As used herein, the term “trap” refers to any device and/or object used for attracting, capturing and/or killing one or more pests. Traps may be natural or man-made. In some embodiments, traps of the present invention may be passive traps. As used herein, the term “passive trap” refers to a stationary trap that relies on the movement of pests to the trap vicinity. Such traps include those described by Ritchie et al (Ritchie, S. A. et al., Journal of Medical Entomology. 2013. 50(1):185-94). In some embodiments, passive traps may not have moving mechanisms, relying on stationary trap components to immobilize pests and/or prevent their escape from the trap area. In some embodiments, traps may comprise a container (such as a box, cylinder, etc) for collecting pests attracted to the trap. In some embodiments, traps may comprise a lure or bait for attracting pests to the trap. Such lures may include, but are not limited to carbon dioxide, carbon dioxide receptor activators (including, but not limited to those compounds disclosed in Table 2), compounds comprising sugars and/or compounds comprising aromatics.

In some embodiments, traps may be lethal traps. As used herein, the term “lethal trap” refers to a trap that kills one or more pests captured by such a trap. Such traps may comprise one or more toxic compounds, such as the carbohydrate biocides and/or toxic sugars described herein, that may be lethal upon exposure to one or more pests (e.g. ingestion, inhalation, etc). In some embodiments, lethal traps kill captured pests by immobilization (e.g. restriction from movement and/or nutritional sources necessary for vitality).

### Kits and Devices

The biocidal compounds and/or compositions of the present invention may be combined with other ingredients or reagents or prepared as components of kits or other retail products for commercial sale or distribution. These kits and/or formulations may be sold to retailers for the purpose of selling these retail products for public use according to the methods disclosed herein. As such the present invention embraces methods of manufacturing or production of kits and/or products to be provided to an end-user. Kits may contain packaging, a vial or container comprising compounds and/or compositions of the present invention and optionally instructions for use.

Biocidal compounds and/or compositions and apparatuses of the present invention may be sold in modular form for assembly, dilution or other method of reconstruction by a subsequent individual or end user as a kit. Said kits may be provided complete with components to assemble the biocidal composition, formulation or apparatus. In another embodiment, said kits provide a partial number of components necessary and require that the subsequent user or end user provide one or more components separately (such as water or other solvent for dilution, rehydration, etc.)

### Equivalents and Scope

Those skilled in the art will recognize, or be able to ascertain using no more than routine experimentation, many equivalents to the specific embodiments in accordance with the invention described herein. The scope of the present invention is not intended to be limited to the above Description, but rather is as set forth in the appended claims.

In the claims, articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention includes embodiments in which more than one, or all of the group members are present in, employed in, or otherwise relevant to a given product or process.

It is also noted that the term “comprising” is intended to be open and permits but does not require the inclusion of additional elements or steps. When the term “comprising” is used herein, the term “consisting of” is thus also encompassed and disclosed.

Where ranges are given, endpoints are included. Furthermore, it is to be understood that unless otherwise indicated or otherwise evident from the context and understanding of one of ordinary skill in the art, values that are expressed as ranges can assume any specific value or subrange within the stated ranges in different embodiments of the invention, to the tenth of the unit of the lower limit of the range, unless the context clearly dictates otherwise.

Where the term “about” is used, it is understood to reflect+/−10% of the recited value.

In addition, it is to be understood that any particular embodiment of the present invention that falls within the prior art may be explicitly excluded from any one or more of the claims. Since such embodiments are deemed to be known to one of ordinary skill in the art, they may be excluded even if the exclusion is not set forth explicitly herein. Any particular embodiment of the compounds and/or compositions, any method of production, any method of use, etc. can be excluded from any one or more claims, for any reason, whether or not related to the existence of prior art.

All cited sources, for example, references, publications, databases, database entries, and art cited herein, are incorporated into this application by reference, even if not expressly stated in the citation. In case of conflicting statements of a cited source and the instant application, the statement in the instant application shall control.

Section and table headings are not intended to be limiting.

### Examples

### Example 1. Larvicidal Activity Assay

A 6-well plate (Corning Life Sciences, Tewksbury, Mass.) is used to test a compound's larvicidal activity. Approximately 20 larvae are added to each well under the following conditions: negative control (larvae are combined with 5 mL of distilled water); positive control (larvae are combined with 4.5 mL of distilled water with 0.5 mL of ethanol); treatment 1 [larvae are combined with 5 mL of a solution comprising 100 parts per million (ppm) of compound A]; treatment 2 (larvae are combined with 5 mL of a solution comprising 0.25% compound A); treatment 3 (larvae are combined with 5 mL of a solution comprising 100 ppm of compound B); treatment 4 (larvae are combined with 5 mL of a solution comprising 0.25% compound B). After a 24 hour exposure, the number of dead larvae are counted and recorded.

### Example 2. Biocidal Activity Assay

The room is conditioned to 26° C. and 60-70% relative humidity. Bottles, lids and mesh coverings to be used are washed with plain dish soap. Bottles and lids are allowed to dry completely. A piece of number 1 Whattman filter paper is added to the bottom of each bottle. Forceps are used to properly position the filter paper against the bottom of the bottle. Each bottle is labeled with the dilution concentration to be applied to the filter paper. Serial dilutions are prepared in test tubes, starting with a dilution of 20 mg/mL. Tubes are labeled with the appropriate dilution concentrations.

Test compounds are subjected to serial dilution in eppendorf tubes, starting with a dilution of 20 mg/ml in 1000 μl of acetone and generating 10-fold dilutions in each successive tube. 500 μl of each solution (including an acetone-only control) is applied to the filter paper in corresponding bottles and allowed to dry. 20 unstarved female mosquitoes are transferred into each bottle and the tops are sealed with mesh. Bottles are then placed into the conditioned experiment room for two hours. Mosquitoes are then observed and the number of catatonic mosquitoes in each bottle is recorded.

### Example 3. Attractive Toxic Sugar Assay

Experiments were carried out to examine the lethality of compounds of the present invention using an attractive toxic sugar assay. These experiments were carried out in 6 groups according to Table 3.

TABLE 3
Experimental groups

| | | Sugar |
|---|---|---|
| Group | Sugars tested | Conc. |
| 1 | D-(+)-raffinose pentahydrate; sucrose | 0.10% |
| | octasulfate aluminum complex; glycyrrhizic | |
| | acid ammonium salt | |
| 2 | D-(+)-turanose; 4-o-beta-galactopyranosyl- | 0.10% |
| | D-mannopyranose; D-(+)-cellobiose | |
| 3 | methyl-beta-D-galactopyranoside; | 0.10% |
| | alpha,beta-trehalose; melibiose | |
| 4 | rutin hydrate; n-acetyl allolactosamine | 0.10% |
| 5 | methyl-beta-D-galactopyranoside; rutin | 0.50% |
| | hydrate; D-(+)-Turanose | |
| 6 | 1:1 sucrose:melibiose; 1:1 | 1% of |
| | sucrose:glycyrrhizic acid ammonium salt; 1:1 | each |
| | sucrose:methyl-beta-D-galactopyranoside | |

### Set Up

The experimental room was conditioned with 75% humidity or higher. Experimental cages were prepared by adding paper towels to the cage bottoms. Cages of mosquitoes were collected (about 25 males and about 25 females per cage), one cage for each sugar bait being tested with an extra cage to use as a sucrose-only control. 1 μl of each test compound was combined with 10 ml of 10% sucrose. Feeding cups were prepared with 10 ml of experimental sugar bait to a cup. In some experiments, blue food coloring was added to verify sugar consumption in the frass. Bait cups were mixed by gentle swirling and wicks were added through the top. Control bait cups received about 10 ml of prepared 10% sucrose solution (except where otherwise indicated).

### Monitoring

Heat, humidity as well as humidifier water content were checked each day. Cages were examined daily for dead mosquitoes. The number of dead mosquitoes per gender was recorded each day. Frass content was examined daily and compared with that of sucrose control.

### Break-Down and Final Counts

After three days, final observations were made and live mosquitoes were removed from each experimental cage and placed into cups for examination under the dissecting scope to determine whether or not female mosquitoes had fed. Once feeding females had been determined for populations from each cage, cups were frozen and discarded. Dead mosquitoes in each cage were counted and the sex of each determined. The relative frass content per cage was compared to that of the sucrose control cage. Frass levels were assigned a rating of some frass present (+), similar to control levels of frass (+++) or less than control (++). Percent (%) lethality was calculated for each treatment group by dividing the total (male and female) number of dead mosquitoes by the total number of mosquitoes for each. Results are presented in Tables 4-9 below.

TABLE 4
Group 1 results

| | | % |
|---|---|---|
| Sugar Name | Conc. | Lethality |
| D-(+)-raffinose pentahydrate | 0.10% | 38.8 |
| sucrose octasulfate aluminum | 0.10% | 39.6 |
| complex | | |
| glycyrrhizic acid ammonium salt | 0.10% | 68.3 |

TABLE 5
Group 2 results

| | | % |
|---|---|---|
| Sugar Name | Conc. | Lethality |
| D-(+)-turanose | 0.10% | 66 |
| 4-O-beta-galactopyranosyl-D- | 0.10% | 55 |
| mannopyranose | | |
| D-(+)-cellobiose | 0.10% | 52 |
| sucrose control | 10% | 6 |

TABLE 6
Group 3 results

| | | % |
|---|---|---|
| Sugar Name | Conc. | Lethality |
| methyl-beta-D- | 0.10% | 65.9 |
| galactopyranoside | | |
| alpha,beta-trehalose | 0.10% | 56.2 |
| melibiose | 0.10% | 64.4 |
| sucrose control | 10% | 3.7 |

TABLE 7
Group 4 results

| | | % |
|---|---|---|
| Sugar Name | Conc. | Lethality |
| rutin hydrate | 0.10% | 58 |
| n-acetyl | 0.10% | 44 |
| allolactosamine | | |
| sucrose control | 10% | 0 |

TABLE 8
Group 5 results

| | | % | |
|---|---|---|---|
| Sugar Name | Conc. | Lethality | Frass |
| methyl-beta-D- | 0.50% | 43 | ++ |
| galactopyranoside | | | |
| rutin hydrate | 0.50% | 45 | + |
| D-(+)-turanose | 0.50% | 29 | +++ |
| sucrose control | 0.50% | 0 | +++ |

TABLE 9
Group 6 results

| | | % | |
|---|---|---|---|
| Sugar Name | Conc. | Lethality | Frass |
| 1:1 sucrose:melibiose | 1% of | 12 | +++ |
| | each | | |
| 1:1 sucrose:glycyrrhizic | 1% of | 52 | + |
| acid ammonium salt | each | | |
| 1:1 sucrose:methyl-beta-D- | 1% of | 25 | +++ |
| galactopyranoside | each | | |
| sucrose control | 2% | 2 | +++ |
| water only control | — | 17 | + |

Frass evaluations presented in Tables 8 and 9 indicate that all compounds were consumed. Interestingly, experiments carried out with water only as a control, yielded % lethality of 17%, indicating that some death may be attributed to malnutrition. It was also noted that % lethality among male mosquitoes was typically elevated in response to toxic sugar consumption as compared to female mosquitoes.

1. A carbohydrate biocide composition comprising one or more toxic sugars selected from the group consisting of monosaccharides, disaccharides, oligosaccharides and saponins at a concentration of from about 0.01% to about 10%.

2. The carbohydrate biocide composition of claim 1 wherein said monosaccharides comprise methyl-beta-D-galactopyranoside.

3. The carbohydrate biocide composition of claim 1 wherein said disaccharides are selected from the group consisting of alpha,beta-trehalose, D-(+)-cellobiose, melibiose, n-acetyl allolactosamine, 4-O-beta-galactopyranosyl-D-mannopyranose, D-(+)-turanose and rutin hydrate.

4. The carbohydrate biocide composition of claim 1 wherein said oligosaccharides comprise D-(+)-raffinose pentahydrate.

5. The carbohydrate biocide composition of claim 1 wherein said saponins comprise glycyrrhizic acid ammonium salt.

6. The carbohydrate biocide composition of claim 1 comprising sucrose.

7. The carbohydrate biocide composition of claim 1 comprising one or more attractant compounds.

8. The carbohydrate biocide composition of claim 7 wherein one or more toxic sugars are also attractants.

9. The carbohydrate biocide composition of claim 8 wherein one or more toxic sugars may be consumed by one or more pests.

10. The carbohydrate biocide composition of claim 9 wherein consumption by one or more pests leads to the death of said one or more pests.

11. A method of controlling one or more pests comprising contacting said one or more pests with one or more carbohydrate biocide compositions according to claim 1.

12. The method of claim 11 wherein said controlling one or more pests comprises one or more of retarding growth, retarding reproduction, repelling, neutralizing harmful effects, sterilizing, immobilizing and killing said one or more pests.

13. The method of claim 12 wherein said one or more carbohydrate biocide compositions are consumed by said one or more pests.

14. The method of claim 13 wherein said one or more carbohydrate biocide compositions are lethal.

15. The method of claim 11 wherein said one or more pests comprise one or more vector pests.

16. The method of claim 15 wherein said one or more vector pests are selected from the group consisting of mosquitoes, sand flies, black flies and biting midges.

17. The method of claim 16, wherein said mosquitoes are of the genus Anopholes, Culex or Aedes.

18. The method of claim 15 wherein said one or more vector pests are flying dipterans selected from the group consisting of members of the mosquito family Culicidae (including, but not limited to members of the genus Aedeomyia, members of the genus Aedes (including, but not limited to Aedes aegypti), members of the genus Anopheles (including, but not limited to Anopheles gambiae and Anopheles annulipes), members of the genus Armigeres, members of the genus Ayurakitia, members of the genus Bironella, members of the genus Borichinda, members of the genus Chagasia, members of the genus Coquillettidia, member of the genus Culex (including, but not limited to Culex quinquefasciatus, Culex molestus, Culex annulirostris and Culex australicus), members of the genus Culiseta, members of the genus Deinocerites, members of the genus Eretmapodites, members of the genus Ficalbia, members of the genus Galindomyia, members of the genus Haemagogus, members of the genus Heizmannia, members of the genus Hodgesia, members of the genus Isostomyia, members of the genus Johnbelkinia, members of the genus Kimia, members of the genus Limatus, members of the genus Lutzia, members of the genus Malaya, members of the genus Mansonia, members of the genus Maorigoeldia, members of the genus Mimomyia, members of the genus Onirion, members of the genus Opifex, members of the genus Orthopodomyia, members of the genus Psorophora, members of the genus Runchomyia, members of the genus Sabethes, members of the genus Shannoniana, members of the genus Topomyia, members of the genus Toxorhynchites, members of the genus Trichoprosopon, members of the genus Tripteroides, members of the genus Udaya, members of the genus Uranotaenia, members of the genus Verrallina, members of the genus Wyeomyia, members of the genus Zeugnomyia), biting midges of the family Ceratopogonidae (including, but not limited to members of the genus Culicoides (including, but not limited to Culicoides sonorensis), members of the genus Leptoconops (including, but not limited to Leptoconops albiventris and Leptoconops torrens) and members of the genus Forcipomyia), black flies of the family Simuliidae (including, but not limited to members of the genus Simulium (including, but not limited to Simulium damnosum, Simulium neavei, Simulium callidum, Simulium metallicum, Simulium ochraceum, Simulium colombaschense, Simulium pruinosum and Simulium posticatum) and sand flies (including but not limited to members of the genus Lutzomyia (including, but not limited to Lutzomyia longipalpis) and members of the genus Phlebotomus (including, but not limited to Phlebotomus papatasi)).

19. A method of trapping one or more pests comprising the use of one or more carbohydrate biocide compositions according to claim 1 in conjunction with a trap.

20. The method of claim 19 wherein said one or more carbohydrate biocide compositions are attractants for said one or more pests.

21. The method of claim 19 wherein said one or more carbohydrate biocide compositions are used to control said one or more pests from overcrowding said trap and/or a bait or lure present in, on or around said trap.
